(19) United States
(12) Patent Application Publication
(10) Pub. No.: US 2017/0316127 A1
(43) Pub. Date: Nov. 2, 2017

(54) METHOD AND APPARATUS FOR CONSTRUCTING TESTING SCENARIO FOR DRIVERLESS VEHICLE

(71) Applicant: Baidu Online Network Technology (Beijing) Co., Ltd., Beijing (CN)

(72) Inventors: Zheng HAN, Beijing (CN); Yi XU, Beijing (CN); Taiqun HU, Beijing (CN); Fenghui HAN, Beijing (CN); Chuting TAN, Beijing (CN)

(21) Appl. No.: 15/280,371

(22) Filed: Sep. 29, 2016

(30) Foreign Application Priority Data
Apr. 29, 2016 (CN) 201610284404.7

(51) Int. Cl. G06F 17/50; G06K 9/00

(52) U.S. Cl. CPC G06F 17/5009; G06K 9/00825; G06K 9/00798; G06K 9/00805; G06K 9/00818

(57) ABSTRACT

The present application discloses a method and apparatus for constructing a testing scenario for a driverless vehicle. An embodiment of the method includes: acquiring a traffic image including a scenario object, the scenario object comprising a roadway object, a traffic sign object, a vehicle object, or a pedestrian object; acquiring attribute information of the scenario object based on the traffic image; and constructing the testing scenario for the driverless vehicle based on the scenario object and the attribute information. The present application enables constructing the testing scenario for the driverless vehicle with real attributes of a roadway object, a traffic sign object, a vehicle object, or a pedestrian object. Therefore, a real traffic condition is restored and employed as the testing environment for the driverless vehicle, and the accuracy of the driverless vehicle testing is improved.

### CROSS-REFERENCE TO RELATED APPLICATIONS

This application is related to and claims priority from Chinese Application No. 201610284404.7, filed on Apr. 29, 2016, entitled “METHOD AND APPARATUS FOR CONSTRUCTING TESTING SCENARIO FOR DRIVERLESS VEHICLE,” the entire disclosure of which is hereby incorporated by reference.

### TECHNICAL FIELD

The present application relates to artificial intelligence, specifically to driverless vehicles, and more specifically to a method and apparatus for constructing a testing scenario for a driverless vehicle.

### BACKGROUND

Vehicle testing is an important means to improve vehicle safety. To conduct a vehicle testing, a testing scenario including elements such as roads, vehicles, and pedestrians needs to be constructed. Then, the testing scenario is simulated in order to complete the vehicle testing. At present, the testing scenario is usually constructed by manually setting attributes such as positions and speeds of the respective elements in the scenario.

However, the testing scenario constructed in the above-mentioned manner will result in the following defects. On one hand, all feasible values of the elements need to be considered with regard to the attributes of each element, which is extremely costly. On the other hand, any error of the element attribute deviated from the real value caused by the manual setting will further increase the error of the entire testing scenario, which results in a distortion of the testing scenario, and thus reduces the accuracy of the vehicle testing.

### SUMMARY

The present application provides a method and apparatus for constructing a testing scenario for a driverless vehicle, so as to solve the technical problem mentioned in the Background.

According to a first aspect, the present application provides a method for constructing a testing scenario for a driverless vehicle, the method comprising: acquiring a traffic image including a scenario object, the scenario object comprising a roadway object, a traffic sign object, a vehicle object, or a pedestrian object; acquiring attribute information of the scenario object based on the traffic image; and constructing the testing scenario for the driverless vehicle based on the scenario object and the attribute information.

According to a second aspect, the present application provides an apparatus for constructing a testing scenario for a driverless vehicle, the apparatus comprising: an image acquiring unit, configured to acquire a traffic image including a scenario object, the scenario object comprising a roadway object, a traffic sign object, a vehicle object, or a pedestrian object; an attribute information acquiring unit, configured to acquire attribute information of the scenario object based on the traffic image; and a scenario constructing unit, configured to construct the testing scenario for the driverless vehicle based on the scenario object and the attribute information.

The method and apparatus for constructing the testing scenario for the driverless vehicle according to the present application enables constructing the testing scenario for the driverless vehicle with real attributes of a roadway object, a traffic sign object, a vehicle object, or a pedestrian object. Therefore, a real traffic condition is restored and employed as the testing environment for the driverless vehicle, and the accuracy of the driverless vehicle testing is improved. This is implemented by acquiring a traffic image including a scenario object, the scenario object comprising a roadway object, a traffic sign object, a vehicle object, or a pedestrian object; acquiring attribute information of the scenario object based on the traffic image; and constructing the testing scenario for the driverless vehicle based on the scenario object and the attribute information.

### BRIEF DESCRIPTION OF THE DRAWINGS

Other features, objectives and advantages of the present application will become more apparent upon reading the detailed description to non-limiting embodiments with reference to the accompanying drawings, wherein:

FIG. 1 illustrates a flow chart of a method for constructing a testing scenario for a driverless vehicle according to an embodiment of the present application;

FIG. 2 illustrates a principle diagram of a simulation to a testing scenario for a driverless vehicle according to the present application;

FIG. 3 illustrates a schematic structural diagram of an apparatus for constructing a testing scenario for a driverless vehicle according to an embodiment of the present application; and

FIG. 4 is a schematic structural diagram of a computer system adapted to implement a terminal device or a server of the embodiments of the present application.

### DETAILED DESCRIPTION

The present application will be further described below in detail in combination with the accompanying drawings and the embodiments. It should be appreciated that the specific embodiments described herein are merely used for explaining the relevant disclosure, rather than limiting the disclosure.

In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

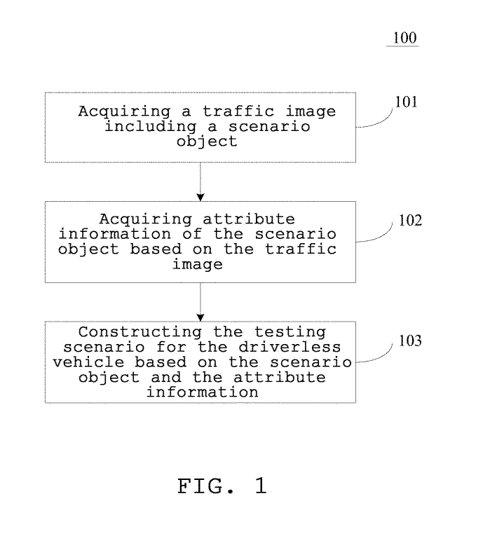

Reference is made to FIG. 1, which illustrates a flow 100 of a method for constructing a testing scenario for a driverless vehicle according to an embodiment of the present application. The method comprises the following steps.

At step 101, a traffic image comprising a scenario object is acquired.

In this embodiment, some scenario objects used for constructing the testing scenario for the driverless vehicle may be selected in advance. These scenario objects may comprise, but not limited to, a roadway object, a traffic sign object, a vehicle object, or a pedestrian object.

In some optional implementations of this embodiment, the traffic image comprising the scenario object is acquired by acquiring, from a third-party traffic monitoring platform, a traffic image captured via a monitor disposed at a junction of an urban roadway.

In this embodiment, the traffic image may be a traffic image captured, via a monitor disposed at each junction of urban roadways, by a third-party traffic monitoring platform for monitoring an urban traffic condition, for example, the traffic monitoring platform of the traffic authority. The traffic image captured via the monitor disposed at each junction of the urban roadways may comprise a roadway object, a traffic sign object on the roadway, as well as a vehicle object and a pedestrian object on the roadway. The traffic sign object may comprise, but not limited to, a lane line, a traffic sign board, an indicator, and a traffic light.

At step 102, attribute information of the scenario object is acquired based on the traffic image.

In this embodiment, the attribute information of the scenario object comprises: a topological structure, a movement speed, a movement direction, and a movement state.

In this embodiment, after the traffic image comprising the scenario object (such as the roadway object, as well as the vehicle object and the pedestrian object on the roadway object) is acquired at step 101, the attribute information of the scenario object may be acquired based on the traffic image.

In some optional implementations of this embodiment, the attribute information of the scenario object is acquired based on the traffic image by acquiring, from an electronic map, a topology structure of a roadway and a position of a traffic sign of the roadway segment corresponding to the location where the traffic image is captured, and employing the topology structure and the position as the attribute information of the roadway object and the traffic sign object.

In this embodiment, the roadway segment corresponding to the capturing location may be determined in the electronic map according to the location where the traffic image is captured. Then, the roadway topology structure, the traffic sign on the roadway, and the position of the traffic sign on the roadway of the roadway segment corresponding to the capturing location may be acquired from the electronic map. The topology structure of the roadway and the position of the traffic sign on the roadway are employed as the attribute information of the roadway object and the traffic sign object. In this way, the attribute information of the roadway object and the traffic sign object is acquired.

In some optional implementations of this embodiment, the attribute information of the scenario object is acquired based on the traffic image by determining positions of the vehicle object and the pedestrian object in each frame of traffic image, respectively; calculating movement speeds, movement directions, and movement states of the vehicle object and the pedestrian object based on the positions of the vehicle object and the pedestrian object in each frame of traffic image, respectively; and employing the movement speeds, movement directions, and movement states of the vehicle object and the pedestrian object as the attribute information of the vehicle object and the pedestrian object.

In this embodiment, the vehicle object and the pedestrian object in the traffic image may be recognized first. For example, the vehicle object and the pedestrian object in the traffic image may be recognized through a deep learning model. After the vehicle object and the pedestrian object in the traffic image are recognized, the positions of the vehicle object and the pedestrian object in the image may be determined. Then, the positions of the vehicle object and the pedestrian object may be calculated according to the positions of the vehicle object and the pedestrian object in the image and a relationship between a coordinate system corresponding to the monitor that captures the image and a coordinate system corresponding to the positions of the vehicle object and the pedestrian object.

In this embodiment, the movement speeds, movement directions, and movement states of the vehicle object and the pedestrian object may be calculated according to positions of the vehicle object and the pedestrian object in a plurality of successively captured traffic images. Then, the calculated movement speeds, movement directions, and movement states of the vehicle object and the pedestrian object are employed as the attribute information of the vehicle object and the pedestrian object. In this way, the attribute information, such as the movement speeds, movement directions, and movement states of the vehicle object and the pedestrian object is acquired.

In this embodiment, the movement speed and movement direction may be calculated in the following manner. The calculations to the movement speed and the movement direction of the vehicle object are taken as an example. In order to calculate the movement speed of the vehicle object, among a plurality frames of successively captured traffic images, the coordinate of the center point of the vehicle profile in the first frame and the coordinate of the center point of the vehicle profile in the last frame may be acquired respectively. Then, a difference between the coordinate of the center point of the vehicle profile in the above-mentioned last traffic image and the coordinate of the center point of the vehicle profile in the first traffic image may be calculated. The difference may be divided by the capturing period corresponding to the plurality frames of successively captured traffic images in order to obtain an average speed of the vehicle in this period. In order to calculate the movement direction of the vehicle object, a deviation between the position of the vehicle and a lane line may be determined according to the position of the lane line and the position of the vehicle, and thus the movement direction of the vehicle may be determined according to the deviation. The movement speed and the movement direction of the pedestrian object may be determined based on the above-mentioned process for determining the movement speed and the movement direction of the vehicle object.

In this embodiment, the movement states of the vehicle object and the pedestrian object may be calculated in the following manner. The calculation to the movement state of the vehicle object is taken as an example. The state of the vehicle may be determined according to a change in the coordinates of the center points of the vehicle profiles in temporal neighboring traffic images. For example, when the change in the coordinates of the center points of the vehicle profiles in two temporal neighboring traffic images is less than a threshold, it may be determined that the vehicle object is braked, and the movement state of the vehicle object may be a braking state. The movement state of a pedestrian object may be determined based on the above-mentioned process for determining the movement state of a vehicle object.

At step 103, the testing scenario for the driverless vehicle is constructed based on the attribute information.

In this embodiment, after the attribute information of the scenario objects, for example, the topology structure of the roadway object, the position of the traffic sign object, and the movement speeds, movement directions, and movement states of the vehicle object and the pedestrian object, is acquired at step 102, the testing scenario for the driverless vehicle may be constructed based on the scenario objects (such as the roadway object, the traffic sign object, the vehicle object, and the pedestrian object) and the attribute information of the roadway object, the traffic sign object, the vehicle object, and the pedestrian object. In this way, in the constructed testing scenario, the topology structure of the roadway object is a real topology structure of the roadway, the position of the traffic sign object is a real position of the traffic sign object on the roadway, and the movement speeds, movement directions, and movement states of the vehicle and the pedestrian are real movement speeds, movement directions, and movement states of the vehicle and the pedestrian. Therefore, a real traffic is restored and employed as a testing environment for a driverless vehicle.

In some optional implementations of this embodiment, after the testing scenario for the driverless vehicle is constructed based on the scenario object and the attribute information, the method further comprises: configuring, based on the attribute information, an attribute of a simulated object in a simulator the simulated object corresponding to the scenario object; and simulating, based on the simulated object, the testing scenario for the driverless vehicle through the simulator.

In some optional implementations of this embodiment, the simulator is the open-source vehicle testing environment simulation framework OpenDrive.

In this embodiment, after the testing scenario is constructed, the constructed testing scenario for the driverless vehicle may be simulated through the simulator, such that the driverless vehicle may be tested under a real traffic condition.

In this embodiment, the simulator may be the open-source vehicle testing environment simulation framework OpenDrive. The OpenDrive framework comprises a simulated object corresponding to the roadway object, a simulated object corresponding to the traffic sign object, a simulated object corresponding to the vehicle object, and a simulated object of a user-defined type, for example, a simulated object corresponding to the pedestrian object.

When the testing environment for the driverless vehicle is simulated, the simulated objects corresponding to the roadway object, the traffic sign object, the vehicle object, and the pedestrian object may be created in the OpenDrive framework first. Then, attributes of the simulated objects may be configured based on the acquired roadway object, traffic sign object, vehicle object, and pedestrian object. For example, the acquired attribute information of the roadway object, the traffic sign object, the vehicle object, and the pedestrian object may be assigned to the corresponding attributes of the corresponding simulated objects. In this way, when the constructed testing scenario for the driverless vehicle is simulated through the OpenDrive framework, the real topology structure of the roadway object, the real position of the traffic sign object on the roadway, and the real movement speeds, movement directions, and movement states of the vehicle and the pedestrian may be restored with the configured simulated objects. Therefore, a real traffic condition is restored and employed as the testing environment for the driverless vehicle, and the accuracy of the driverless vehicle testing is improved.

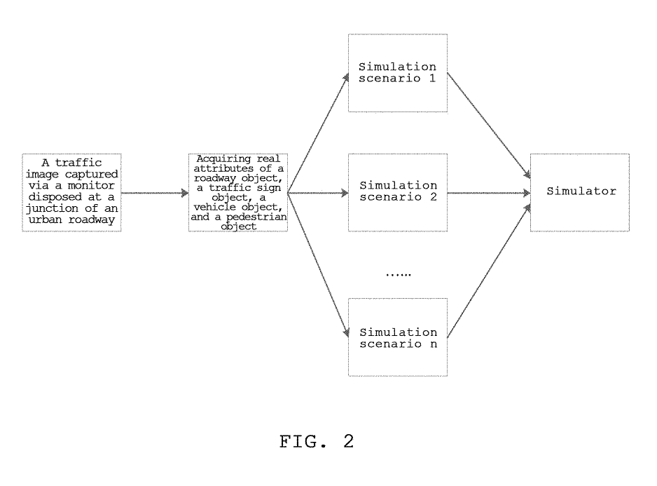

Reference is made to FIG. 2, which illustrates a principle diagram of a simulation to a testing scenario for a driverless vehicle according to the present application.

When the testing scenario for the driverless vehicle is to be simulated, a traffic image captured via a monitor disposed at a junction of an urban roadway may be acquired. After the traffic image captured via the monitor disposed at the junction of the urban roadway is acquired, real attributes of a roadway object, a traffic sign object, a vehicle object, or a pedestrian object may be acquired. That is, attribute information of the roadway object, the traffic sign object, the vehicle object, and the pedestrian object may be acquired. The attribute information of the roadway object comprises a topology structure of the roadway object. The attribute information of the traffic sign object comprises the position of the traffic sign object. The attribute information of the vehicle object and the pedestrian object comprises movement speeds, movement directions, and movement states of the vehicle object and the pedestrian object.

The testing scenario for the driverless vehicle may be constructed according to the scenario object and the acquired attribute information of the scenario object. The scenario object may comprise, but not be limited to, the roadway object, the traffic sign object, the vehicle object, and the pedestrian object. The testing scenario may also be referred to as a simulation scenario. The simulation scenario comprises a real topology structure of the roadway, a real position of the traffic sign on the roadway, and real movement speeds, movement directions, and movement states of the vehicle object and the pedestrian object on the roadway.

A plurality of different simulation scenarios may be constructed based on attributes of the roadway object, the traffic sign object, the vehicle object, and the pedestrian object in different roadway segments. After the plurality of different simulation scenarios are constructed, the different simulation scenarios may be simulated through a simulator. Thus, a real traffic condition is restored and employed as the testing scenario for the driverless vehicle, in order to implement a driverless vehicle test.

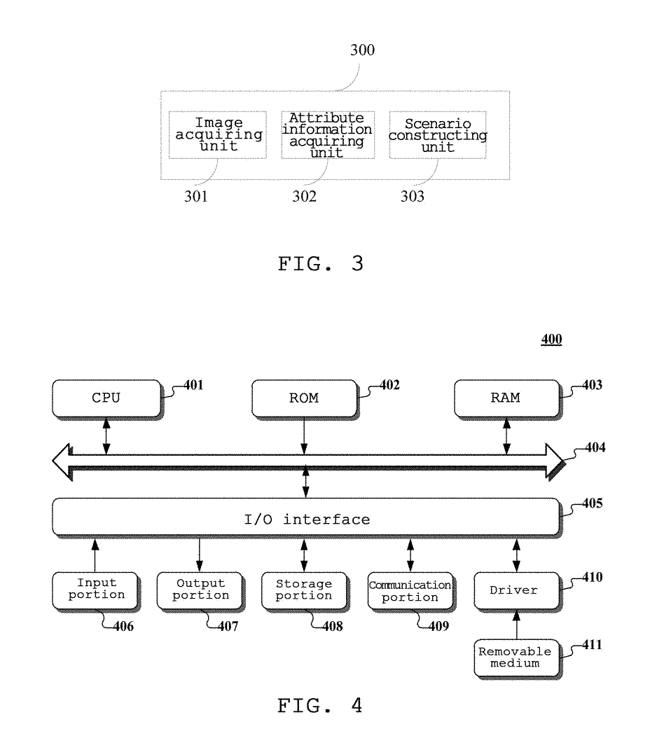

Referring to FIG. 3, as an implementation of the methods shown in the above drawings, the present application provides an embodiment of an apparatus for constructing a testing scenario for a driverless vehicle. This apparatus embodiment corresponds to the method embodiment as shown in FIG. 1. The apparatus may be specifically implemented in various electronic devices.

As shown in FIG. 3, the apparatus 300 for constructing the testing scenario for the driverless vehicle according to this embodiment comprises: an image acquiring unit 301, an attribute information acquiring unit 302, and a scenario constructing unit 303. The image acquiring unit 301 is configured to acquire a traffic image including a scenario object, the scenario object comprising a roadway object, a traffic sign object, a vehicle object, or a pedestrian object. The attribute information acquiring unit 302 is configured to acquire attribute information of the scenario object based on the traffic image. The scenario constructing unit 303 is configured to construct the testing scenario for the driverless vehicle based on the scenario object and the attribute information.

In some optional implementations of this embodiment, the image acquiring unit 301 comprises: a traffic image acquiring subunit, configured to acquire, from a third-party traffic monitoring platform, a traffic image captured via a monitor disposed at a junction of an urban roadway.

In some optional implementations of this embodiment, the attribute information acquiring unit 302 comprises: a first attribute information acquiring subunit (not shown), configured to acquire, from an electronic map, a topology structure of a roadway and a position of a traffic sign of a roadway segment corresponding to a location where the traffic image is captured; and a first attribute information configuring subunit (not shown), configured to employ the topology structure and the position as the attribute information of the roadway object and the traffic sign object.

In some optional implementations of this embodiment, the attribute information acquiring unit 302 comprises: a second attribute information acquiring subunit (not shown), configured to determine positions of the vehicle object and the pedestrian object in each frame of the traffic image, respectively; a calculating subunit (not shown), configured to calculate, based on the positions of the vehicle object and the pedestrian object in the each frame of the traffic image, movement speeds, movement directions, and movement states of the vehicle object and the pedestrian object, respectively; and a second attribute information configuring subunit (not shown), configured to employ the movement speeds, movement directions, and movement states of the vehicle object and the pedestrian object as the attribute information of the vehicle object and the pedestrian object.

In some optional implementations of this embodiment, the apparatus 300 further comprises: a simulated object configuring unit (not shown), configured to configure, based on the attribute information, an attribute of a simulated object in a simulator, the simulated object corresponding to the scenario object; and a simulation unit (not shown), configured to simulate, based on the simulated object, the testing scenario for the driverless vehicle through the simulator.

In some optional implementations of this embodiment, the simulator is the open-source vehicle testing environment simulation framework OpenDrive.

FIG. 4 illustrates a schematic structural diagram of a terminal device or computer system adapted to implement the embodiments of the present application.

As shown in FIG. 4, the computer system 400 comprises a central processing unit (CPU) 401, which may execute various appropriate actions and processes in accordance with a program stored in a read-only memory (ROM) 402 or a program loaded into a random access memory (RAM) 403 from a storage portion 408. The RAM 403 also stores various programs and data required by operations of the system 400. The CPU 401, the ROM 402 and the RAM 403 are connected to each other through a bus 404. An input/output (I/O) interface 405 is also connected to the bus 404.

The following components are connected to the I/O interface 405: an input portion 406 including a keyboard, a mouse etc.; an output portion 407 comprising a cathode ray tube (CRT), a liquid crystal display device (LCD), a speaker etc.; a storage portion 408 including a hard disk and the like; and a communication portion 409 comprising a network interface card, such as a LAN card and a modem. The communication portion 409 performs communication processes via a network, such as the Internet. A driver 410 is also connected to the I/O interface 405 as required. A removable medium 411, such as a magnetic disk, an optical disk, a magneto-optical disk, and a semiconductor memory, may be installed on the driver 410, to facilitate the retrieval of a computer program from the removable medium 411, and the installation thereof on the storage portion 408 as needed.

In particular, according to an embodiment of the present disclosure, the process described above with reference to the flowcharts may be implemented in a computer software program.

For example, an embodiment of the present disclosure comprises a computer program product, which comprises a computer program that is tangibly embedded in a machine-readable medium. The computer program comprises program codes for executing the method of the flowcharts. In such an embodiment, the computer program may be downloaded and installed from a network via the communication portion 409, and/or may be installed from the removable media 411.

The flowcharts and block diagrams in the figures illustrate architectures, functions and operations that may be implemented according to the system, the method and the computer program product of the various embodiments of the present disclosure. In this regard, each block in the flowcharts and block diagrams may represent a module, a program segment, or a code portion. The module, the program segment, or the code portion comprises one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flow charts and/or a combination of the blocks may be implemented by a dedicated hardware-based system executing specific functions or operations, or by a combination of a dedicated hardware and computer instructions.

In another aspect, the present application further provides a nonvolatile computer readable storage medium. The nonvolatile computer readable storage medium may be the nonvolatile computer readable storage medium comprised in the apparatus in the above embodiments, or a stand-alone nonvolatile computer readable storage medium which has not been assembled into the apparatus. The nonvolatile computer readable storage medium stores one or more programs, which when executed by a device, cause the device to: acquiring a traffic image including a scenario object, the scenario object comprising a roadway object, a traffic sign object, a vehicle object, or a pedestrian object; acquiring attribute information of the scenario object based on the traffic image; and constructing the testing scenario for the driverless vehicle based on the scenario object and the attribute information.

The foregoing is only a description of the embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the disclosure, such as, technical solutions formed by replacing the features as disclosed in the present application with (but not limited to), technical features with similar functions.

What is claimed is:

1. A method for constructing a testing scenario for a driverless vehicle, the method comprising:
acquiring a traffic image including a scenario object, the scenario object comprising a roadway object, a traffic sign object, a vehicle object, or a pedestrian object;
acquiring attribute information of the scenario object based on the traffic image; and
constructing the testing scenario for the driverless vehicle based on the scenario object and the attribute information.

2. The method according to claim 1, wherein the acquiring of the traffic image including the scenario object comprises: acquiring, from a third-party traffic monitoring platform, a traffic image captured via a monitor disposed at a junction of an urban roadway.

3. The method according to claim 1, wherein the acquiring of the attribute information of the scenario object based on the traffic image comprises:
acquiring, from an electronic map, a topology structure of a roadway and a position of a traffic sign of a roadway segment corresponding to a location where the traffic image is captured; and
employing the topology structure and the position as the attribute information of the roadway object and the traffic sign object.

4. The method according to claim 3, wherein the acquiring of the attribute information of the scenario object based on the traffic image comprises:
determining respective positions of the vehicle object and the pedestrian object in each frame of the traffic image;
calculating, based on the positions of the vehicle object and the pedestrian object in the each frame of the traffic image, respective movement speeds, movement directions, and movement states of the vehicle object and the pedestrian object; and
employing the movement speeds, the movement directions, and the movement states of the vehicle object and the pedestrian object as the attribute information of the vehicle object and the pedestrian object.

5. The method according to claim 4, wherein after the constructing of the testing scenario for the driverless vehicle based on the scenario object and the attribute information, the method further comprises:
configuring, based on the attribute information, an attribute of a simulated object in a simulator, the simulated object corresponding to the scenario object; and
simulating, based on the simulated object, the testing scenario for the driverless vehicle through the simulator.

6. The method according to claim 5, wherein the simulator is the open-source vehicle testing environment simulation framework OpenDrive.

7. An apparatus for constructing a testing scenario for a driverless vehicle, the apparatus comprising:
at least one processor; and
a memory storing instructions, which when executed by the at least one processor, cause the at least one processor to perform operations, the operations comprising:
acquiring a traffic image including a scenario object, the scenario object comprising a roadway object, a traffic sign object, a vehicle object, or a pedestrian object;
acquiring attribute information of the scenario object based on the traffic image; and
constructing the testing scenario for the driverless vehicle based on the scenario object and the attribute information.

8. The apparatus according to claim 7, wherein the acquiring of the traffic image including the scenario object comprises:
acquiring, from a third-party traffic monitoring platform, a traffic image captured via a monitor disposed at a junction of an urban roadway.

9. The apparatus according to claim 7, wherein the acquiring of the attribute information of the scenario object based on the traffic image comprises:
acquiring, from an electronic map, a topology structure of a roadway and a position of a traffic sign of a roadway segment corresponding to a location where the traffic image is captured; and
employing the topology structure and the position as the attribute information of the roadway object and the traffic sign object.

10. The apparatus according to claim 9, wherein the acquiring of the attribute information of the scenario object based on the traffic image comprises:
determining positions of the vehicle object and the pedestrian object in each frame of the traffic image respectively;
calculating, based on the positions of the vehicle object and the pedestrian object in the each frame of the traffic image, movement speeds, movement directions, and movement states of the vehicle object and the pedestrian object respectively; and
employing the movement speeds, the movement directions, and the movement states of the vehicle object and the pedestrian object as the attribute information of the vehicle object and the pedestrian object.

11. The apparatus according to claim 10, wherein after the constructing of the testing scenario for the driverless vehicle based on the scenario object and the attribute information, the operations further comprises:
configuring, based on the attribute information, an attribute of a simulated object in a simulator, the simulated object corresponding to the scenario object; and
simulating, based on the simulated object, the testing scenario for the driverless vehicle through the simulator.

12. The apparatus according to claim 11, wherein the simulator is the open-source vehicle testing environment simulation framework OpenDrive.

13. Anon-transitory storage medium storing one or more programs, the one or more programs when executed by an apparatus, causing the apparatus to perform a method for constructing a testing scenario for a driverless vehicle, comprising:
acquiring a traffic image including a scenario object, the scenario object comprising a roadway object, a traffic sign object, a vehicle object, or a pedestrian object;
acquiring attribute information of the scenario object based on the traffic image; and
constructing the testing scenario for the driverless vehicle based on the scenario object and the attribute information.
